(19) United States
(12) Patent Application Publication
(10) Pub. No.: US 2023/0240932 A1
(43) Pub. Date: Aug. 3, 2023

(54) EXOSKELETON SYSTEM

(71) Applicant: OZYEGIN UNIVERSITESI, Istanbul (TR)

(72) Inventors: Ramazan UNAL, Istanbul (TR); Baris AKIN, Istanbul (TR); Sinan EMRE, Istanbul (TR)

(73) Assignee: OZYEGIN UNIVERSITESI, Istanbul (TR)

(21) Appl. No.: 18/013,001

(22) PCT Filed: Dec. 30, 2020
(86) PCT No.: PCT/TR2020/051460

§ 371 Date: Dec. 27, 2022

(51) Int. Cl. A61H 3/00; A61H 1/02

(52) U.S. Cl. CPC A61H 3/00; A61H 1/024; A61H 2003/007; A61H 2201/164; A61H 2201/1671; A61H 2201/165

(57) ABSTRACT

An exoskeleton system in order to provide walking support to people who have disability in walking or in order to provide performance improvement to healthy people includes at least one first body for being connected to the motionless upper part of the leg and at least one second body for being connected to the motionless lower part of the leg and at least one knee embodiment provided between said first body and said second body in a manner allowing motion of the knee joint, and at least one foot embodiment for forming support to the foot part by being connected to the second body. The improvement of the exoskeleton system is that said knee embodiment includes at least one isogram mechanism provided in a manner supporting the bio-mechanical motion of the knee joint from the side (sagittal plane) part of the knee joint.

### CROSS REFERENCE TO THE RELATED APPLICATIONS

This application is the national phase entry of International Application No. PCT/TR2020/051460, filed on Dec. 30, 2020, the entire contents of which are incorporated herein by reference.

### TECHNICAL FIELD

The present invention relates to at least one exoskeleton system in order to provide walking support to people who have disability in walking or in order to provide performance improvement to healthy people, and having at least one first body for being connected to the motionless upper part of the leg and at least one second body for being connected to the motionless lower part of the leg and at least one knee embodiment provided between said first body and said second body in a manner allowing movement of the knee, and at least one foot embodiment for forming support to the foot part by being connected to the second body.

### BACKGROUND

Mechanical exoskeleton has been designed for supporting the person who wears it, for walking assistance and/or for increasing performance thereof. For instance, mechanical exoskeleton is used for supporting and/or for increasing performance of soldiers or construction workers. Moreover, development of exoskeletons which can support movement of elderly people and individuals with injuries, i.e. spinal cord injury or stroke, enables a wide medical market in the future. The other areas where advantage is provided are rescue works; heavy debris can be lifted by a lifeguard who wears this machine in collapsed buildings and at the same time, protection can be provided against falling taluses.

In the Chinese application with number CN201110292009, an exoskeleton rehabilitation robot is described. Proposed robot provides supporting of the foot of the user from the base, it is a circular support mechanism developed beside the knee. While the leg support is provided by means of a rod-like structure provided at the side part, it is apparent that ergonomic problems also occur.

The mechanical exoskeleton can also be used in military fields for augmenting the performance development of the soldiers. However, around the knee joint, ergonomics problems occur which result from the unfavorable coinciding of the inner frame and the exoskeleton system.

As a result, because of the aforementioned problems, an improvement is required in the related technical field.

### SUMMARY

The present invention relates to an exoskeleton system, for eliminating the aforementioned disadvantages and for bringing new advantages to the related technical field.

An object of the present invention is to provide an exoskeleton system which allows ergonomic usage such that it does not project from the leg periphery.

In order to realize the abovementioned objects and the objects which are to be deducted from the detailed description below, the present invention is at least one exoskeleton system in order to provide walking support to people who have disability in walking or in order to provide performance improvement to healthy people, and having at least one first body for being connected to the motionless upper part of the leg and at least one second body for being connected to the motionless lower part of the leg and at least one knee embodiment provided between said first body and said second body in a manner allowing movement of the knee, and at least one foot embodiment for forming support to the foot part by being connected to the second body. Accordingly, the improvement of the present invention is that said knee embodiment includes at least one isogram mechanism provided in a manner supporting the bio-mechanical motion of the knee joint from the side (sagittal plane) part of the knee, said isogram mechanism includes at least one movement element which can be manipulated by means of at least one energy storage element which allows carrying load, in order to compensate for the translational motion realized by the knee joint while rotating. Thus, an ergonomic usage is provided by supporting the bio-mechanical motion of the knee joint from the side part.

In a possible embodiment of the present invention, at least one first part of the knee embodiment where the knee embodiment is connected to the first body and at least one second part where the knee embodiment is connected to the second body are provided in a manner extending from the front part of the knee towards the rear part of the knee in a compliant manner to the bio-mechanics of the knee joint. Thus, coinciding of the inner frame of the user and the exoskeleton system is provided, and thus, an ergonomic usage is provided.

In another possible embodiment of the present invention, for supporting the foot ankle from the front part thereof, said foot embodiment includes at least one connection bracket connected to the second body so as not to project from the foot periphery. Thus, the foot and ankle joint is supported in a manner not protruding outwardly.

In another possible embodiment of the present invention, the foot embodiment includes at least one foot plate which can be connected to the foot base, and at least one finger plate associated with said foot plate in a movable manner with respect to each other. Thus, the foot base and the finger part are supported.

In another possible embodiment of the present invention, the first body is connected to the leg upper part by means of at least one thigh connection element. Thus, the first body is connected to the thigh part of the leg in a manner completely seating from the front side thereof.

In another possible embodiment of the present invention, the second body is connected to the leg lower part by means of at least one calf connection element. Thus, the second body is connected to the shank (tibia) part of the leg in a manner completely seating from the front side thereof.

In another possible embodiment of the present invention, the isogram mechanism is configured to fit the user around the knee and the foot part of the foot embodiment. Thus, it is enabled that the exoskeleton system fits the leg and foot periphery, and since it does not project outwardly, a usage advantage is provided.

### BRIEF DESCRIPTION OF THE DRAWINGS

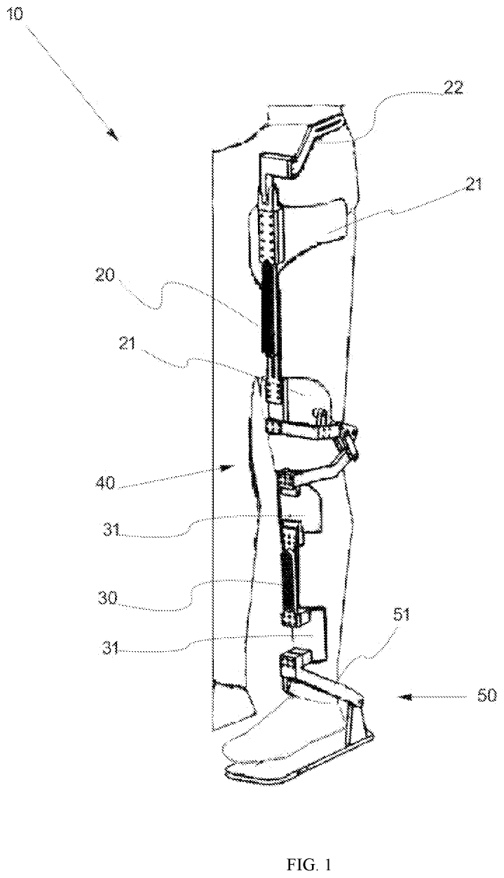

In FIG. 1, a representative perspective view of the subject matter exoskeleton system is connected onto a leg is given.

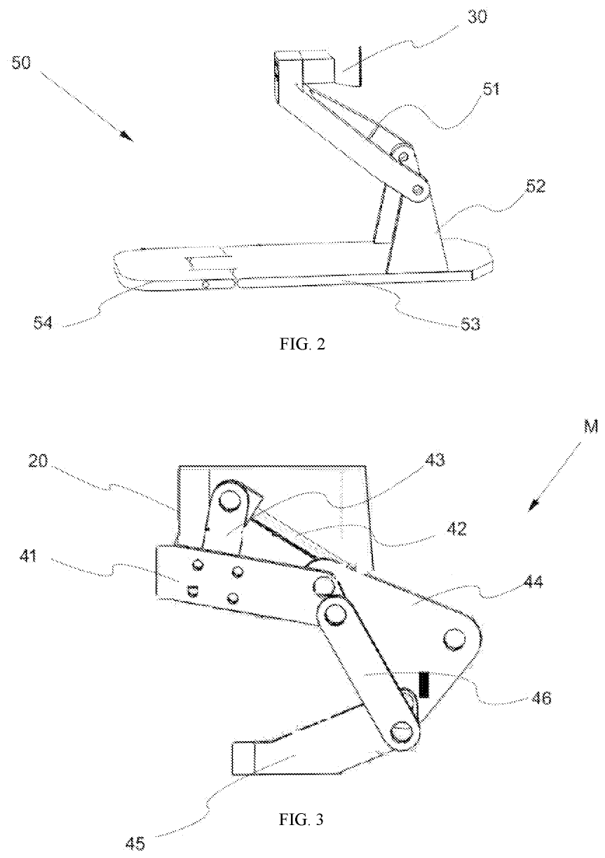

In FIG. 2, a representative perspective view of a foot embodiment of the subject matter exoskeleton system is given.

In FIG. 3, a representative perspective view of isogram mechanism in a knee embodiment of the subject matter exoskeleton system is given.

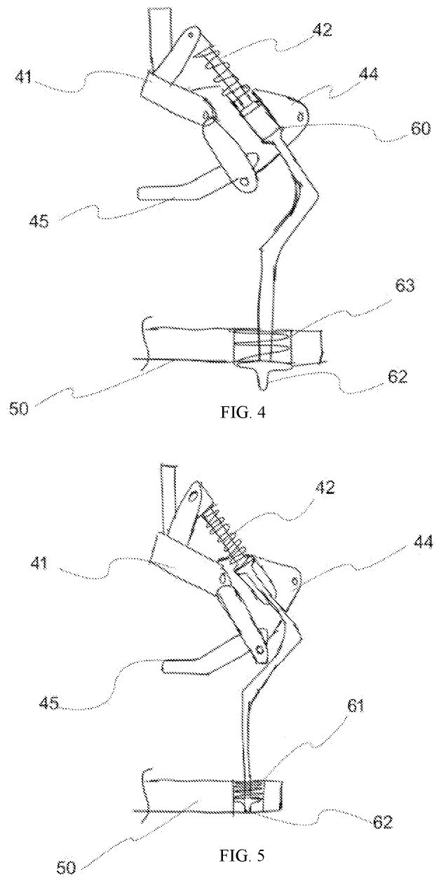

In FIG. 4, a representative perspective view of a condition where the support of the subject matter exoskeleton system is disengaged is given.

In FIG. 5, a representative perspective view of a condition where the support of the subject matter exoskeleton system is engaged is given.

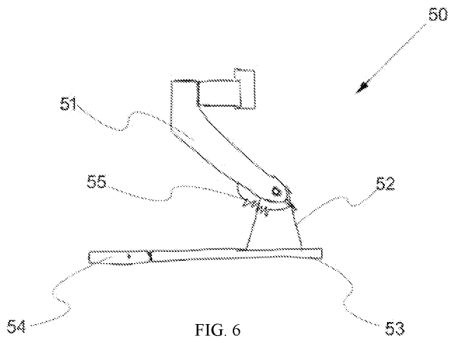

In FIG. 6, a representative perspective view where a plantar-flexion support element is positioned in a foot embodiment of the subject matter exoskeleton system is given.

### REFERENCE NUMBERS

10 Exoskeleton system
20 First body
21 Thigh connection element
22 Waist connection element
30 Second body
31 Shank connection element
40 Knee embodiment
41 First part
42 Energy storage element
43 Positioning element
44 Movement element
45 Second part
46 Third part
50 Foot embodiment
51 Connection bracket
52 Plate connection element
53 Foot plate
54 Finger plate
55 Plantar-flexion support element
60 Activation housing
61 Spring
62 Locking element
63 Housing
M Isogram mechanism

### DETAILED DESCRIPTION OF THE EMBODIMENTS

In this detailed description, the subject matter exoskeleton system (10) is explained with references to examples without forming any restrictive effect only to make the subject more understandable.

In FIG. 1, a representative perspective view where the subject matter exoskeleton system (10) is connected onto a leg is given. Accordingly, the exoskeleton system (10) is a mechanical support associated with the leg from outside for providing walking support in people who have disability in walking or for providing performance improvement in healthy people. In humans, leg is the organ which extends from the waist part to the foot part by means of two motionless parts and two joints. The part which extends from the buttock to the knee joint is named as thigh and the part which extends from the knee joint to the ankle joint is named as shank. The exoskeleton system (10) includes at least one first body (20) for being connected to the thigh part of the leg from the front side thereof. Said first body (20) is a structural support element and it is essentially a frame. The first body (20) includes at least one waist connection element (22) provided in a manner connected to the waist part of the user. The first body (20) includes at least one thigh connection element (21). Said thigh connection element (21) is essentially a holder structure and provides the connection of the first body (20) to the thigh part of the leg. In a possible embodiment of the present invention, two thigh connection elements (21) are provided where one of them is connected to the upper region of the thigh part and where the other one of them is connected to the part of the thigh part which is relatively close to the knee.

The exoskeleton system (10) includes at least one second body (30) to be connected to the calf part of the leg from the front side thereof. Said second body (30) is a structural support element and is essentially a frame. The second body (30) includes at least one shank connection element (31). Said shank connection element (31) is essentially a holder structure and provides the second body (30) to be connected to the calf part of the leg. In a possible embodiment of the present invention, two shank connection elements (31) are provided where one of them is connected to the upper region of the calf part and where the other one of them is connected to the part of the calf part which is relatively close to the foot.

In FIG. 2, a representative perspective view of a foot embodiment (50) of the subject matter exoskeleton system (10) is given. Accordingly, said foot embodiment (50) is a support frame provided for forming support to the foot part of the exoskeleton system (10) and particularly for forming support to the ankle joint. The foot embodiment (50) is connected to the second body (30). The foot embodiment (50) includes at least one foot plate (53). Said foot plate (53) is a partially flat plate provided at equal dimensions as the user foot base. The foot embodiment (50) includes at least one finger plate (54). Said finger plate (54) is a plate which allows partially positioning on the finger parts of the user. The finger plate (54) and the foot plate (53) are configured to be movable with respect to each other. The movement is formed naturally in the walking behavior that is supported. The foot plate (53) and the finger plate (54) are moved concerning for walking behavior during walking, and the foot embodiment (50) supports the ankle joint of the user. The foot embodiment (50) includes at least one plantar-flexion support element (55). Said plantar-flexion support element (55) is an auxiliary item for supporting the leg in the movement towards the plantar side during ankle push off.

The foot embodiment (50) includes at least one connection bracket (51) for supporting the ankle joint from the front part thereof. Said connection bracket (51) provides the foot embodiment (50) to be connected to the second body (30) in a manner fitting the leg and not protruding from the leg periphery. The connection bracket (51) essentially has a geometric structure that is similar to inverse V including two arms. The connection bracket (51) is connected to the foot plate (53) by means of at least one plate connection element (52). Said plate connection element (52) is essentially a supporting part. The plate connection element (52) is mutually provided to be connected with both arms of the connection bracket (51).

The exoskeleton system (10) includes at least one knee embodiment (40). Said knee embodiment (40) provides the knee joint to move between the first body (20) and the second body (30). The knee embodiment (40) includes at least one isogram mechanism (M) provided in a manner supporting the bio-mechanical motion of the knee joint from the rear part of the knee. Said isogram mechanism (M) is a movement mechanism for compensating the translational motion realized by the knee joint while rotating. The isogram mechanism (M) is connected to the first body (20) by means of at least one first part (41). The isogram mechanism (M) is connected to the second body (30) by means of at least one second part (45). Said first part (41) and said second part (45) are provided in a manner extending from the front part of the knee joint towards the rear part of the knee joint in the sagittal plane in a compliant manner to the bio-mechanics of the knee joint.

The isogram mechanism (M) includes at least one movement element (44). Said movement element (44) is a movable plate provided essentially in triangular form. The movement element (44) is associated with the first part (41) from one end of the long edge and is associated with the second part (45) from the other part thereof. The movement element (44) is connected to at least one energy storage element (42) from another end thereof. Said energy storage element (42) is essentially a spring and provides driving of the movement element (44). The energy storage element (42) is connected to at least one positioning element (43) from the other side thereof. Said positioning element (43) is a support which provides connection of the energy storage element (42) to the first body (20). The isogram mechanism (M) includes at least one third part (46). Said third part (46) is essentially a linear supporting element connected between the first part (41) and the second part (45).

In FIG. 4 and FIG. 5, the representative perspective views where the subject matter exoskeleton system (10) support is disengaged and where the subject matter exoskeleton system (10) support is engaged are given respectively. Accordingly, in the isogram mechanism (M), at least one activation housing (60) is provided where the energy storage element (42) can move therein. Said activation housing (60) is essentially a slot which will provide engagement and disengagement of the support. The exoskeleton system (10) includes at least one locking element (62). Said locking element (62) is essentially provided in a sliding form. The locking element (62) is connected to at least one housing (63) for passing through the foot base part. Said housing (63) is essentially a channel provided at the rear part of the foot embodiment (50). After the foot is elevated from the ground, the locking element (62) moves downwardly by means of at least one spring (61). Said spring (61) is compressed during upward movement of the locking element (62) when the heel touches the ground, and when the heel is elevated from the ground, the spring (61) returns the stored energy and provides downward movement of the locking element (62). When the locking element (62) passes to the high position, it fixes the position of the energy storage element (42) and provides engagement thereof. Thus, during weight acceptance, the energy storage element (42) realizes weight acceptance support by means of storing energy. When the heel is elevated from the ground, the locking element (62) passes to the low position and provides free movement of the energy storage element (42) in the activation housing (60). Thus, since energy is not stored, the energy storage element (42) has been disengaged, and the free rotation of the knee is provided. This release is needed for not preventing the free flexion of the knee.

By means of all these embodiments, the exoskeleton system (10) is connected to the knee periphery by means of the knee embodiment (40) and is connected to the periphery of the ankle joint by means of the foot embodiment (50), and thanks to this, it does not project from the leg and foot periphery. By being completely fit to the user's leg, it is prevented from getting attached to an outer element. By means of the isogram mechanism (M), an ergonomic usage is presented to the user by means of aligning of the inner frame with the exoskeleton system (10). The energy storage element (42) provides support to the movement of the knee.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. An exoskeleton system in order to provide a walking support to people who have disability in walking or in order to provide a performance improvement to healthy people comprising
at least one first body for being connected to a motionless upper part of a leg, and at least one second body for being connected to a motionless lower part of the leg, and at least one knee embodiment provided between the at least one first body and the at least one second body in a manner allowing a motion of a knee joint, and
at least one foot embodiment for forming a support to a foot part by being connected to the at least one second body,
wherein the at least one knee embodiment comprises at least one isogram mechanism provided in a manner supporting a bio-mechanical motion of the knee joint from a side (sagittal plane) part of the knee joint,
the at least one isogram mechanism comprises at least one movement element, wherein the at least one movement element is configured to be manipulated by means of at least one energy storage element, wherein the at least one energy storage element allows carrying a load, in order to compensate a translation motion realized by the knee joint while rotating.

2. The exoskeleton system according to claim 1, wherein the exoskeleton system further comprises at least one first part of the at least one knee embodiment where the at least one knee embodiment is connected to the at least one first body, and at least one second part where the at least one knee embodiment is connected to the at least one second body, wherein the at least one first part and the at least one second part are provided in a manner extending from a front part of a knee towards a rear part of the knee in a compliant manner to a bio-mechanics of the knee joint.

3. The exoskeleton system according to claim 1, wherein for supporting an ankle joint from a front part of the ankle joint, the at least one foot embodiment comprises at least one connection bracket connected to the at least one second body so as not to project from a foot periphery.

4. The exoskeleton system according to claim 1, wherein the at least one foot embodiment comprises at least one foot plate and at least one finger plate, wherein the at least one foot plate is configured to be connected to a foot base, and the at least one finger plate is associated with the at least one foot plate in a movable manner with respect to each other.

5. The exoskeleton system according to claim 1, wherein the at least one first body is connected to the leg upper part by means of at least one thigh connection element.

6. The exoskeleton system according to claim 1, wherein the at least one second body is connected to the leg lower part by means of at least one shank connection element.

7. The exoskeleton system according to claim 1, wherein the at least one isogram mechanism is configured to fit a user around the knee and the foot part of the at least one foot embodiment.
